(19) United States
(12) Patent Application Publication
(10) Pub. No.: US 2004/0044515 A1
(43) Pub. Date: Mar. 4, 2004

(54) Automated natural language inference system

(76) Inventors: Michael Metcalf, Trabuco Canyon, CA (US); Peter Dingus, Mission Viejo, CA (US)

Correspondence Address: Joseph E. Levi, Zimmerman & Levi, LLP, 226 St. Paul Street, Westfield, NJ, 07090, US

(21) Appl. No.: 10/231,552

(22) Filed: Aug. 30, 2002

(51) Int. Cl. G06F 17/20

(52) U.S. Cl. 704/1

(57) ABSTRACT

An automated natural language inference system that interprets KEYWORDS within a natural language stream to carry out a particular action inferred from such stream and, if necessary, queries the user for more KEYWORDS or natural language CONFIRMATION via a natural language dialog until an inferred action can be fired. The inference engine of the system populates rule TEMPLATES with different permutations of the KEYWORDS, constrained by word-to-slot size and the KEYWORD-to-slot number, to find a rule match. If more than one rule match is found, the rule with the highest priority is selected and fired.

### FIELD OF THE INVENTION

The present invention is related to knowledge-based systems and, more particularly, to an automated natural language inference system that interprets KEYWORDS within a natural language stream to carry out a particular action inferred from such stream and, if necessary, queries the user for more KEYWORDS or natural language CONFIRMATION via a natural language dialog until an inferred action can be fired.

### BACKGROUND OF THE INVENTION

Presently, automated interactive speech system are grammar based. In grammar-based systems, each context has a predetermined set of grammar or phrases that the user must say in order to interact with the system. For example, if the user wants to retrieve their email messages, they may be required to say the phrase “get email.” The behavior of grammar-based automatic speech recognizers (ASRs) is repeatable since the same predetermined set of phrases is required to produce an action within the system. As can be readily seen, such grammar-based ASRs require a very large phrase or grammar dictionary of most every phrase the user population may speak in order to automate the system. Accordingly, grammar-based systems are not very flexible.

In view of the foregoing, there is a continuing need for a knowledge-based system that can infer meaning from the natural language in order to produce an action.

As will be seen more fully below, the present invention is substantially different in structure, methodology and approach from that of the prior automated attendant system systems and methods.

### SUMMARY OF THE INVENTION

The present invention contemplates an automated natural language inference system that includes a plurality of rules, each rule having an associated TEMPLATE. Each template has “slots” into which KEYWORDS of recognized speech of a particular length is inserted. If a filled template matches an associated rule, then such associated rule is fired to execute a predetermined action embedded in the rule.

The present invention further contemplates a template that has weighted slots wherein a weighting factor of a slot is used to determine which rule of the plurality of rules takes preference if more than one populated TEMPLATE has a rule match.

The present invention further contemplates an automated natural language inference system that includes an interaction procedure that queries the user for more KEYWORDS or natural language CONFIRMATION based on the populated TEMPLATES wherein a series of queries may be required until the action is executed.

The above and other objects of the present invention will become apparent from the drawings, the description given herein and the appended claims.

### BRIEF DESCRIPTION OF THE DRAWINGS

FIG. 1 illustrates a general block diagram of the automated natural language inference system in accordance of the present invention.

FIG. 2 illustrates the flowchart of the overall natural language inference process in accordance with the present invention.

FIG. 3 illustrates a flowchart of the process for populating TEMPLATES in accordance with the present invention.

### DETAILED DESCRIPTION OF THE INVENTION

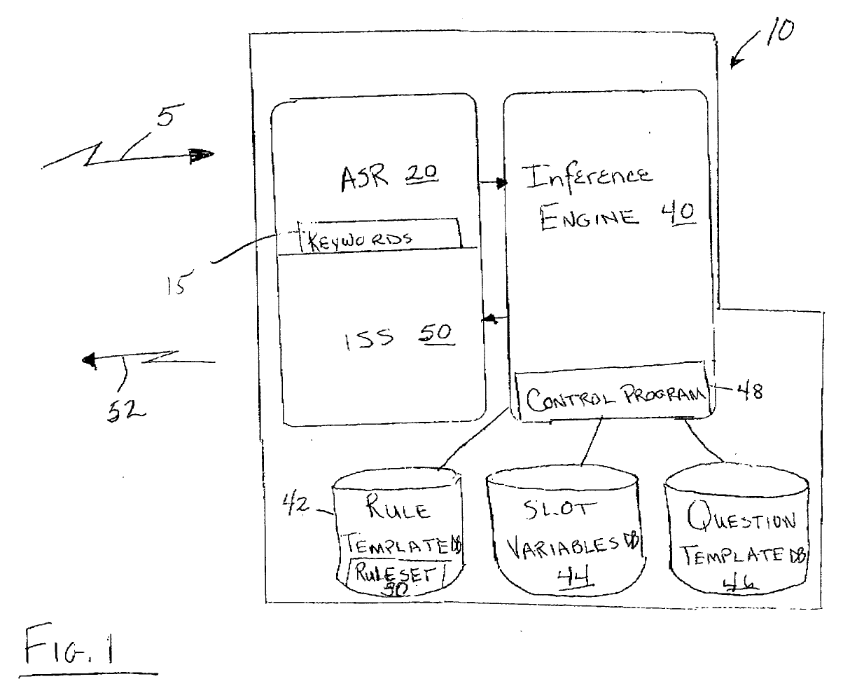

Referring now to the drawings and in particular FIG. 1, the automated natural language inference system 10 includes KEYWORDS 15 from the ASR unit 20 that are derived from the user's spoken words or user's input 5. The system 10 further includes a RULE SET 30 and an inference engine 40 that contains the reasoning logic to process the RULE SET 30 and the recognized speech to derive the KEYWORDS 15. Moreover, the system 10 includes an interactive speech synthesizer unit (ISS) 50 to carryout automated interactive sessions with the user in order to prompt the user for more information to fire an inferred action, as will be described in more detail below.

The inference engine 40 is an inference knowledge-based system. Thereby, people can query system 10 in a more natural way, e.g. use natural language to interact with system 10. In other words, the system 10 employs natural language understanding in the ASR's dialogue flow control.

Referring now to the KEYWORDS, KEYWORDS are derived by the ASR unit 20 in response to user input 5 to create recognized speech. The ASR unit 20 converts the user's speech (input 5) to text, which forms the recognized speech, in order to derive such KEYWORDS 15 wherein each KEYWORD has a word SIZE. The word SIZE is directly proportional to the number of characters in a KEYWORD. These words are communicated, to the inference engine 40, by the ASR unit 20 not as phrases but as KEYWORDS 15 flagged in the grammar interspersed with “GARBAGE MODELS”, i.e. constructs interpreted by the ASR unit 20 as speech as opposed to noise but not associated with words in phrases that the ASR unit 20 uses to calculate recognition scores. The KEYWORDS 15 are then used by the inference engine 40 to fill slots in TEMPLATES of the RULE SET 30.

An example of KEYWORDS 15 in grammar phrases, from the natural language stream of the user, may be expressed as:

<GrammarRule>=check . . . new messages|check . . . +new messages (1)

wherein “check,” “new” and “messages” are KEYWORDS 15 and are used to populate TEMPLATE slots; and, “. . . ” is a GARBAGE MODEL. The inference engine 40 interprets such GARBAGE MODEL as speech filler, not as noise.

In the exemplary embodiment, the RULE SET 30 is a set of IF-THEN rules or other conditional statements. The reasoning logic of the inference engine 40 includes such RULE SET 30 and known facts. An IF-THEN rule is expressed as:

IF [condition] THEN [action]. (2)

Each rule has a condition part (IF) and an action part (THEN). If the left-hand side (the IF part), also called premise, is satisfied, the rule becomes applicable and subject to is fired or executed by the inference engine 40. Each IF-THEN rule is expressed in terms of a TEMPLATE having slots adapted to be populated with the derived KEYWORDS 15. Each slot of the TEMPLATE has a slot SIZE of a predetermined number of characters and a slot VALUE or WEIGHTING FACTOR. For example, with regard to the KEYWORDS 15 of the above exemplary embodiment, a TEMPLATE for a RULE is expressed as:

IF [slot1] for [slot2] [slot3] (3)

THEN return and play [slot2] voicemail messages.

When the TEMPLATE of expression (3) is populated with KEYWORDS 15, the TEMPLATE would be expressed as:

IF [check] for [new] [messages] (4)

THEN return and play [new] voicemail messages

wherein the words populated within the brackets are KEYWORDS 15. However, the KEYWORDS in the THEN part of the expression (3) are derived from the KEYWORDS inserted into the IF part of expression (3).

Examples of other TEMPLATES as expressed in expressions (5) and (6) which include the following:

IF [check] for [old] [messages] (5)

THEN return and play [old] voicemail messages

IF [check] for [deleted] [messages] (6)

THEN return and play [deleted] voicemail messages.

wherein the words populated within the brackets are KEYWORDS.

As can be appreciated, the number and construction of TEMPLATES are enumerable. Accordingly, to describe such TEMPLATES for different industrial applications is prohibitive. EXAMPLE 2 described below provides an exemplary set of TEMPLATES, rules and QUESTIONS.

In operation, all TEMPLATES within the rule template database 42, or a subset within the database 42, are populated with the KEYWORDS 15 in all possible permutations (constrained by word size and slot size). In the exemplary embodiment, the KEYWORD “check” has five (5) letters and fits into a 5-character slot; the KEYWORD “new” has three (3) letters and fits into a 3-character slot; the KEYWORD “messages” has eight (8) letters and fits into a 8-character slot. If a populated TEMPLATE matches a rule, the rule is fired.

While the exemplary embodiment employs IF-THEN rules for retrieving voicemail or email messages, other conditional statements can be used. Examples of other rules or conditional statements can be expressed as:

IF [precondition] THEN [conclusion] (7)

IF [situation] THEN [action] (8)

IF [conditions C1 and C2] hold (9)

THEN [condition C3 does not hold]

wherein C1, C2 and C3 are arbitrary variables. The IF-THEN rules or conditional statements form chains that go from left to right. The elements on the left-hand side of these chains are input information, while those on the right-hand side are derived information.

In view of the forgoing, the IF-THEN rules or conditional statements with forward chains of inference that can connect various types of information, such as without limitation, data to goals; evidence to hypotheses; findings to explanations; observations to diagnoses; and manifestations to causes or diagnoses. Hence, IF-THEN rules are generally a natural form of expressing knowledge.

The IF-THEN rule or other conditional statement preferably would have the following properties: modularability such that, each rule defines a small, relatively independent piece of knowledge; incrementability such that new rules can be added to the knowledge base relatively independently of other rules; modifiability (as a consequence of modularity) such that old rules can be changed relatively independent of other rules; and, supports system's transparency.

The inference engine 40 includes a control program 48 that is essentially an interpreter program to control the order in which the rules of the RULE SET 30 are formed by populating slots of rule TEMPLATES, resolve conflicts if more than one rule is applicable, and finally decide which rules to fire if such rules become TRUE. The control program 48 repeatedly applies rules to the current set of slots of the rule TEMPLATE until all permutations have been evaluated to find all TRUE rules. The control program 48 then selects the best rule or the rule with the highest ranking or preference to fire if more than one rule becomes TRUE.

In operation, as the permutations of populating the slots with the KEYWORDS 15 are created, the control program 48 determines “BAD VARIABLE SLOT ASSOCIATION.” Thereby, the control program 48 determines which permutations, of the populated TEMPLETE do not match the rule or do not make sense against the rule.

Additionally, the control program 48 determines a “CONFUSION SET.” A “CONFUSION SET” is a set of partially filled TEMPLATES. A CONFUSION SET is created when the number of KEYWORDS is less than the number of slots. If more that one TEMPLATE matches an associated rule, the control program 48 will fire the rule that has the greatest total slot VALUE. The VALUES or WEIGHTING FACTORS for each slot is a function of KEYWORD relevance. The higher the relevance of the KEYWORD, the higher the VALUE or WEIGHTING FACTOR of the slot. Thus, ordering of the active rules (rules that make sense) in the CONFUSION SET is given by the sum of the slot VALUES for completed TEMPLATES.

Furthermore, each rule has an associated TEMPLATE with slot variable data stored in a slot variables database 44. Slot variables include the number of slots of a TEMPLATE; slot VALUES; dialogue context; optional words indicated by “( )” parentheses; and, equivalent occurrences indicated by “/” slashes. Examples of a dialogue context includes the different industrial applications such as email and voicemail.

The reasoning logic of the control program 48 is a forward chain data-driven reasoning process where a set of rules is used to derive new facts from an initial set of data. The rule interpreter of the control program 48 applies production rules in the appropriate order to accomplish the task of putting relevant characteristics of the knowledge-based system in working memory and arriving at the best estimated result.

For the “email context,” an exemplary TEMPLATE populated with KEYWORDS is expressed as:

IF [get] (all) [messages/emails] from [NAME] (10)

since (for) past [NUMBER] of days

THEN query email store for messages from NAME since date

wherein the “date” is calculated from the KEYWORD “NUMBER;” and the “NAME” is derived information from the KEYWORDS and is entered in the action part of the IF-THEN rule. The words between “( )” are optional and found in the slot variables database 44.

The TEMPLATE in expression (10) has four (4) slots whose values are given between the square brackets is expressed as (the derived information from the KEYWORDS in the THEN action part does not generally have values):

IF [8] (all) [2] from [10] (11)

since (for) past [10] of days

THEN query email store for messages from NAME since date.

wherein the first slot has a VALUE of 8, the second slot has a VALUE of 2 and the third slot has a VALUE of 10.

Values associated with action part of the rule (or the “Then” clause) do not, generally, lend information to the rule weight. The values that appear in the “Then” clause are generally carried over from the conditional “If” clause with their values double counting the rule weight. Rule weights must be properly normalized (relative weights lie on the same scale) in order to properly reflect their application.

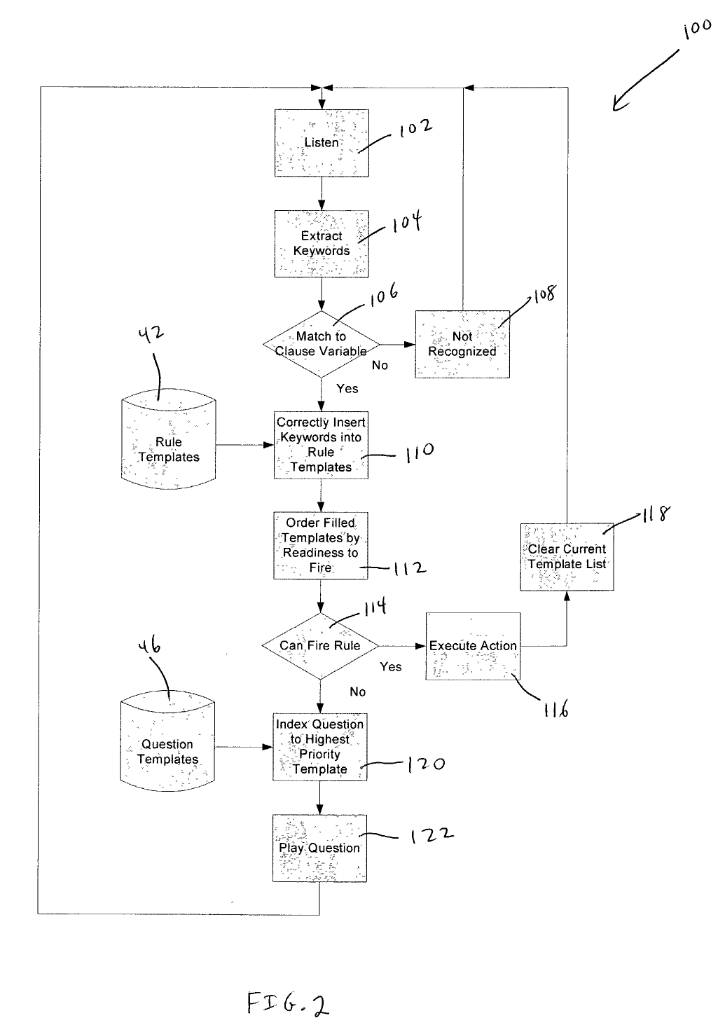

Referring now to FIG. 2, the flowchart of the overall natural language inference process 100 begins at Step 102 where the ASR unit 20 listens and recognizes the speech 5 from the natural language stream from the user. In the exemplary embodiment, speech recognition includes converting the speech to text. Step 102 is followed by Step 104 where the ASR unit 20 extracts KEYWORDS 15 from the recognized speech. KEYWORDS 15 are a function of the industrial application. Examples 1 and 2 set forth below illustrate exemplary sets of KEYWORDS for retrieving messages or emails and banking applications, respectively. Step 104 is followed by Step 106, a determination step, to determine whether any of the extracted KEYWORDS match clause variables. Accordingly, if whatever KEYWORDS currently extracted from the voice stream do not match clause (or rule) variables of a TEMPLATE no new information is added and the system informs the caller that it did not understand the last utterance. The system can respond by re-asking the last question or by asking the caller to repeat themselves, depending on how complete the most competitive rule is.

If the determination is “NO,” then Step 106 is followed by Step 108 where the user is notified that the recognition speech is not recognized. Step 108 returns to the beginning of Step 102, described above.

However, if the determination at Step 106 is “YES,” Step 106 is followed by Step 110 where the ASR unit 20 populates the extracted KEYWORDS into all rule TEMPLATES stored in the rule template database 42. Step 110 is followed by Step 112 where the populated TEMPLATES are ordered in accordance with readiness to fire based on the total slot VALUE of a TEMPLATE. In other words, those TEMPLATES that have the most slots filled have the highest total slot VALUE. Step 112 is followed by Step 114 where a determination is made whether any of the TEMPLATES can be executed. If the determination is “YES,” Step 114 is followed by Step 116 where the system 10 executes the action associated with the TEMPLATE. Step 116 is followed by Step 118 where the current TEMPLATE list is cleared.

However, if there is not a TEMPLATE ready to fire at Step 114 and the determination is “NO,” the Step 114 is followed by Step 120. At Step 120, the system indexes QUESTIONS in the questions template database 46, to the highest priority TEMPLATE. Step 120 is followed by Step 122 where the system 10 plays the QUESTION using a natural language dialog via ISS 50. Step 122 returns back to Step 102 where the process is repeated. In other words, the system 10 repeats various QUESTIONS to query the user for predetermined information so that a valid inferred action can be fired.

As can be appreciated, the natural language dialog conveyed by the QUESTIONS queries the user for missing and necessary KEYWORDS not previously provided or natural language CONFIRMATION to complete the inference determination to fire an action.

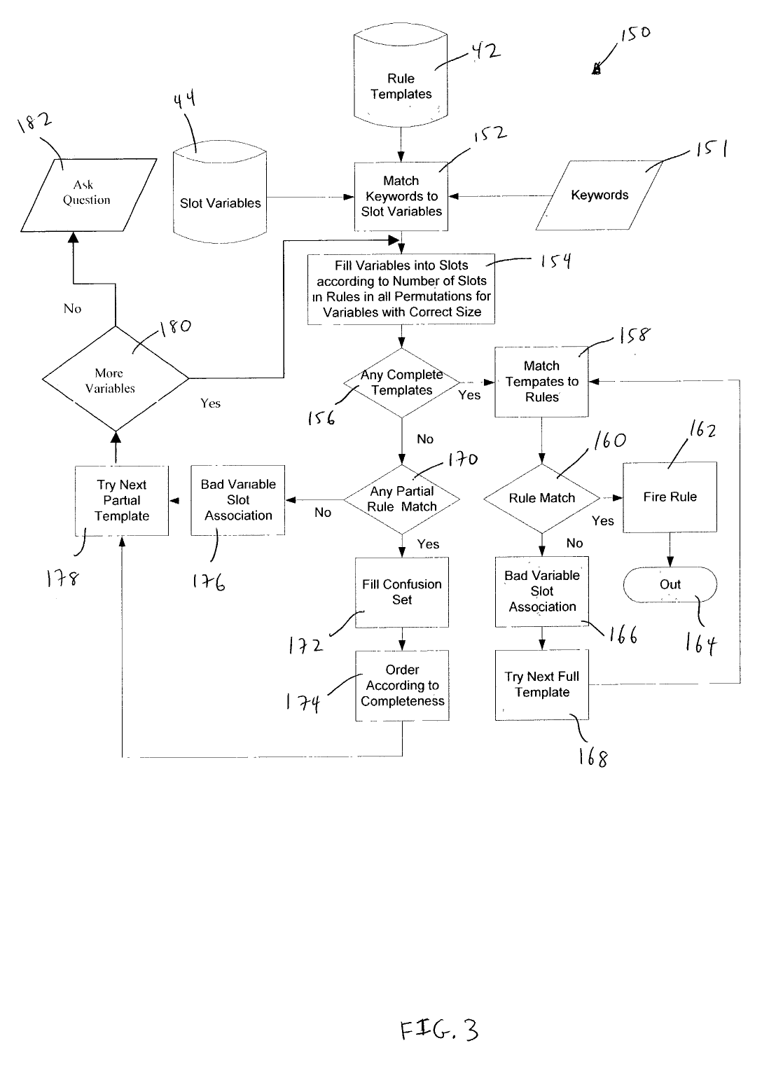

Referring now to FIG. 3, the flowchart of the process 150 for populating TEMPLATES (Step 110 of FIG. 2) begins at Step 152 where KEYWORDS are matched to slot variables. Step 152 receives input from the KEYWORD deriving process Step 151 (Steps 102-106 of FIG. 2), accesses TEMPLATES in rule template database 42 and slot variables database 44. Step 152 is followed by Step 154 where the variables are filled into the slots according to the number of slots in rules in all permutations for variables with correct size. In other words, the KEYWORDS are populated into the slots based on SIZE. Step 154 is followed by Step 156 where a determination is made whether any permutations of the TEMPLATES are complete. If the determination is “YES” at Step 156, then Step 156 is followed by Step 158 where the completed TEMPLATE(s) are matched to the associated RULE SET 30. Step 158 is followed by Step 160 where a determination is made whether there is a rule match. IF there is a rule match at Step 160, then Step 160 is followed by Step 162 where the rule is fired and the associated action executed. Step 162 is followed by Step 164 where the process 150 is terminated. It should be noted, that Steps 158, 160 and 162 map to Steps 112, 114 and 116 of FIG. 2.

However, if the determination is “NO” at Step 160, the Step 160 is followed by Step 166 where the control program 48 determines the BAD VARIABLE SLOT ASSOCIATION. Step 166 is followed by Step 168 where the next full TEMPLATE is retrieved and evaluated such that Step 168 returns to Step 158.

Referring again to Step 156, if the determination at Step 156 is “NO” then Step 156 is followed by Step 170. At Step 170 there is a determination whether there are any partial rule matches. If the determination is “YES” at Step 170, then Step 170 is followed by Step 172 where the CONFUSION SET is filled. Step 172 is followed by Step 174 where the CONFUSION SET is ordered in terms of completeness and total slot VALUE. This is where the slot values are used to determine the firing order.

Step 174 is followed by Step 178 where the next partial TEMPLATE is obtained and evaluated. Step 178 is followed by Step 180, where a determination is made whether there are more variables in the partially filled TEMPLATE. If the determination at Step 180 is “YES,” Step 180 returns to Step 154, described above. However, if the determination is “NO,” Step 180 is followed by Step 182 where a QUESTION is asked. Step 182 is related to Steps 120 and 122 of FIG. 2.

Referring again to Step 170, if the determination at Step 170 is “NO,” then Step 170 is followed by Step 176 where a BAD SLOT ASSOCIATION is determined. Step 176 is followed by Step 178, previously described.

In summary, process 150 includes placing KEYWORDS in slots of rule TEMPLATES in various permutations wherein the placement is constrained by the number of slots in a particular TEMPLATE and the number of available KEYWORDS (Steps 152 and 154). Thereafter, the process 150 includes scanning production rules for TEMPLATE matches (Steps 156 and 158); and, rejecting rules with too few slots, to retain only TEMPLATES with complete or partial correct rule matches.

The process 150 further includes scanning the production rules for those active or applicable, i.e. those whose IF condition evaluates to TRUE. This step generates a list of active rules (which might be null list). (SEE Steps 168 and 178)

Referring also to FIG. 2, if no rules can be made active, the inference engine 40 determines closest probable rules (those with largest percentage of filled slots over some minimum cut off) and ask appropriate leading QUESTIONS in an attempt to satisfy a rule (Steps 120-122). The number of leading QUESTIONS is a variable set. If no rule can be made active in some number of attempts, the system 10 is queued to indicate a miss-recognition (Step 108).

However, if more than one rule becomes active, then the inference engine 40 deactivate those rules with less valuable information. For example, a date in an “email context” is more valuable than the KEYWORD “email” or “message.” This prevents mistakes due to badly formed requests.

Next, the inference engine 40 fires the first active production rule or the complete rule with the most valuable information. If there are no applicable rules, the process is exited and the user is notified of a miss-recognition.

### EXAMPLE 1

### Email Message Retrieval

Below is TABLE 1 illustrating the natural language stream a user may input. The KEYWORDS 15 are derived from the input and the natural language dialog via QUESTIONS from the questions template database 46 or other inferred action.

TABLE 1

| | | SYSTEM | |
|---|---|---|---|
| CONTEXT | USER | (KEYWORDS) | ACTION |
| Main Menu | Check my emails. | Check, emails | Fire Rule1 |
| | What emails do I have. | Emails | Question: do you |
| | How many emails do I have. | Emails | want to check or read |
| | I want my email(s). | Emails | your email |
| | . | . | Question: do you |
| | . | . | want to check or read |
| | . | . | your email |
| | Get my email please | Get, email | Fire Rule2 |
| | (please) read my email | Read, email | Fire Rule2 |
| | Email | Email | Question: do you |
| | I want my email | Email | want to check or read |
| | . | . | your email |
| | . | . | |
| | . | . | |
| Email Context | Go to last/first email/message. | Go, last/first, | Fire Rule1 |
| (complete info) | | email/message | |
| | Go to next/last email/message. | Go, next/last, | Fire Rule2 |
| | | email/message | |
| | Get (all) messages/emails from | Get, messages/email, | Fire Rule3 |
| | NAME. | NAME | |
| | Get (all) messages/emails from | Get, messages/email, | Fire Rule4 |
| | NAME since (for) past NUMBER | NAME, NUMBER | |
| | of days. | | |
| Email Context | Go to last/first email/message. | Go, email/message | Question: which |
| (incomplete | | | email/message would |
| info) | Go to next/last email/message. | | you like to go to? |
| | Get (all) messages/emails from | Get, email/message | Question: from whom |
| | NAME. | | would you like to get |
| | | | messages? |
| | Get (all) messages/emails from | Get, email/message, | |
| | NAME since (for) past NUMBER | NUMBER | |
| | of days | | |
| Email Context | Get (all) messages between start | Get, between, start, end | Fire Rule5 |
| (complete info) | date end date | | |
| | Get (all) messages before date | Get, before, date | Fire Rule6 |
| | Get (all) messages after date | Get, after, date | Fire Rule7 |
| Email Context | Get (all) messages between start | Get, start, end | Fire Rule5 |
| (incomplete | date end date | | |
| info) | | | |
| | Get (all) messages before date | Get, date | Question: do you |
| | Get (all) messages after date | | want messages from |
| | | | before or after this |
| | | | date |

The column titled “USER” illustrates exemplary natural language streams that may be received by the system 10. The column titled “SYSTEM KEYWORDS” illustrates exemplary KEYWORDS that would be recognized by the ASR unit 20. The column titled “ACTION” illustrates various actions that would be inferred by the system 10. When the KEYWORDS do not fill a respective TEMPLATE and permutations thereof, the action would include querying the user via a natural language dialog to get more KEYWORDS or CONFIRMATION of inference.

### EXAMPLE 2

### Natural Language Banking Application

### Glossary

< >=indicates Grammar rule

|=indicates alternate word

{ }=indicates optional word

( )=indicates grouped words

[ ]=indicates variable slot for KEYWORD

[num1,num2]=indicates slot weight, slot question index

### Embedded Grammar

Amountmoney=

<Amount>dollar,

<Amount>dollar and <tydigit> cents,

<Amount>dollar and <teendigit> cents,

<Amount>dollar and <digit> cents,

<tydigit> cents,

<teendigit> cents,

<digit> cents,

Amount=

<digit>, <tydigit>, <teendigit>,

<digit> thousand, <digit> hundred,

<digit> thousand and <digit> hundred,

<digit> hundred and <tydigit>,

<digit> hundred and <teendigit>,

<digit> hundred and <digit>,

<digit>=1, 2, 3, . . . 0;

<tydigit>=10, 20, . . . , 90;

<teendigit>=11, 12, . . . , 19;

<bill>=phone bill|electricity bill|etc;

<sourceDestination>=checking account|savings account|etc;

### Persistent Variables

These variables are not cleared when an action is taken and includes Current account and Amountmoney.

Below is TABLE 2 of a set of Rules and TEMPLATE association for the banking application. The TABLE 2 is exemplary and not to be considered exhaustive.

TABLE 2

| | TEMPLATE |
|---|---|
| RULE | [variable weight, question index] |
| 1) IF [go] to [account] THEN make account | IF [8,1] to [8,2] THEN make account current |
| current and report balance, make | and report balance, make Amountmoney in |
| Amountmoney in account current | account current |
| 2) IF [check \| report \| ] (tell me) {my} [account] | IF [8,1] {my} [8,2] {balance} THEN query |
| {balance} THEN query account and report, | account and report, make account current, |
| make account current, make Amountmoney in | make Amountmoney in account current |
| account current | |
| 3) IF [check \| report \| ] (tell me) [all] (my) | IF [8,1] [5,2] {my} {account} balances THEN |
| {account} balances THEN query account and | query all accounts and report |
| report | |
| 4) IF {transfer} [Amountmoney] [from] | IF {[8]} [8,1] [10,2] [8,3] THEN transfer |
| [sourceDestination] THEN transfer | Amountmoney from source to current account |
| Amountmoney from source to current account | |
| 5) IF {transfer} [Amountmoney] [to] | IF {[8]} [8,1] [10,2] [8,3] THEN transfer |
| [sourceDestination] THEN transfer | Amountmoney to destination from current |
| Amountmoney to destination from current | account |
| account | |
| 6) IF {transfer} [Amountmoney] [from] | IF {[8]} [10,1] [8,2] [8,3] [8,4] [8,5] THEN |
| [account1] [to] [account2] THEN transfer | transfer Amountmoney from account1 to |
| Amountmoney from account1 to account2, | account2 make account1 current, make |
| make account1 current, make Amountmoney | Amountmoney in account1 current |
| in account1 current | |
| 7) IF {transfer} [Amountmoney] [from] | IF {[8]} [8,1] [8,2] [8,3] THEN transfer |
| [account] THEN transfer {Amountmoney} | Amountmoney from account to current |
| from account to current account | account |
| 8) IF {transfer} [Amountmoney] [to] [account] | IF {[8]} [8,1] [8,2] [8,3] THEN transfer |
| THEN transfer Amountmoney to account from | Amountmoney to account from current |
| current account | account |
| 9) IF [pay] {the} [bill] THEN pay the bill with | IF [8,1] [8,2] THEN pay the bill with bill ID = |
| bill ID = bill from current account | bill from current account |

The column titled “Rule” identifies TRUE TEMPLATES with the KEYWORDS identified in “[ ]”. The column titled “TEMPLATES” illustrates templates, with the WEIGHTING FACTOR and index number of the QUESTION in the template question database 46. The QUESTION and index are set forth below in TABLE 3.

Below is TABLE 3 and exemplary listing of QUESTIONS to carry out the natural language dialog to retrieve more KEYWORDS or CONFIRMATION. The numbered pairs in the “QUESTION” column indicate (rule, variable). For example, (4,3) means the 3^{rd} variable in the 4^{th} rule which is “[sourceDestination]”. Thus, for the question “How much do you wish to transfer from (4,3)”, the (4,3) would map to [sourceDestination]. The slot index number is the order of the slots as it appears in the TEMPLATE.

TABLE 3

| RULE, SLOT INDEX | QUESTION (Rule, Variable) |
|---|---|
| 1, | If you want to go to account, say go to account. |
| 1,2 | Which account do you want to go to? |
| 2,1 | If you want to check account, say check |
| | account. |
| 2,2 | Which account do you want to check? |
| 3,1 | If you want to check all accounts, say check all |
| | accounts. |
| 3,2 | If you want to check all accounts, say check all |
| | accounts. |
| 4,1 | How much do you wish to transfer from (4,3)? |
| 4,2 | If you wish to transfer money from (4,3), say |
| | transfer ((4,1) \| money) from (4,3). |
| 4,3 | From where do you want to transfer ((4,1) \| |
| | money)? |
| 5,1 | How much do you wish to transfer to (5,3)? |
| 5,2 | If you wish to transfer money to (5,3), say |
| | transfer ((5,1) \| money) to (5,3). |
| 5,3 | To where do you want to transfer ((5,1) \| |
| | money)? |
| 6,1 | How much do you wish to transfer from |
| | ((6,3) \| the source account) to ((6,5) \| the |
| | destination account)? |
| 6,2 | If you wish to transfer money from (6,3), say |
| 6,3 | transfer ((6,1) \| money) to (6,3). |
| 6,4 | If you wish to transfer money to (6,5), say |
| 6,5 | transfer ((6,1) \| money) to (6,5). |
| 7,1 | How much do you wish to transfer from (7,1)? |
| 7,2 | If you wish to transfer money from (7,3), say |
| | transfer ((7,1) \| money) from (7,3). |
| 7,3 | From where do you want to transfer ((7,1) \| |
| | money)? |
| 8,1 | How much do you wish to transfer from (8,1)? |
| 8,2 | If you wish to transfer money to (8,3), say |
| | transfer ((8,1) \| money) to (8,3). |
| 8,3 | To where do you want to transfer ((8,1) \| |
| | money)? |
| 9,1 | If you wish to pay ((9,2) \| (a bill), say pay |
| | ((9,2) \| (the bill). |
| 9,2 | Which bill do you wish to pay? |

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

What is claimed is:

1. An automated a natural language interactive inference system comprising:
an automatic speech recognition unit for recognizing natural language and identifying keywords therein, each keyword has a word size;
a template associated with a rule for firing an action wherein the template has slots each slot has a slot size; and,
an inference engine that populates slots of the template with the keywords having a word size equal to the slot size wherein if a populated template matches the rule, the action is fired.

2. The system according to claim 1, wherein the inference engine populates the slots using keyword permutations constrained by slot size and a number of the keywords to a number of the slots and creates an active rule list therefrom.

3. The system according to claim 2, wherein each slot has a weighting factor that is used to determine which rule in the active rule list takes preference if more than one template permutation is matched to the rule.

4. The system according to claim 1, wherein the inference engine includes an interaction procedure that queries a user for more information based on a partially-populated template.

5. The system according to claim 4, wherein the partially-populated template has a highest priority of a list of partially-populated templates.

6. The system according to claim 1, wherein the automatic speech recognition unit converts the natural language into text and identifies keywords within the text and communicates the keywords to the inference engine.

7. The system according to claim 1, wherein each slot has a set of slot variables, the slot variables include the number of the slots of the template; a weighting factor of each slot; dialogue context; optional words; and, equivalent word occurrences.

8. The system according to claim 7, wherein the dialogue context is a function of the keyword recognition and includes email applications, voicemail applications or banking applications.

9. A method of automatically inferring natural language for an interactive natural language system comprising the steps of:
placing keywords in slots of rule templates in various permutations to create populated templates;
scanning production rules to determine which populated template has a production rule match;
during the scanning step, retaining the populated templates with complete or partial rule matches in an active rule list; and, firing a rule in the active rule list that has highest priority.

10. The method according to claim 9, wherein the step scanning step includes the steps of:
if no rules can be made active, during the retaining step, determining closest probable rules with largest percentage of populated slots over some minimum cut off; and,
querying using a natural language dialog a leading question in an attempt to satisfy a rule.

11. The method according to claim 10, further comprising the step of:
if no rule can be made active in a number querying steps, indicating a miss-recognition.

12. The method according to claim 9, further comprising prior to the placing step, the steps of:
receiving natural language speech;
converting the speech into text; and,
parsing the text into the keywords.

13. The method according to claim 9, wherein the placing step is constrained by a slot sizes in the template and the sizes of available keywords.

14. The method according to claim 13, wherein the placing step is constrained by a number of slots in the template and a number of the available keywords.

15. The method according to claim 9, wherein the slots have weighting factors to determine which of the rules has the highest priority.

16. The system according to claim 9, wherein the keywords are a function of industrial application which includes email applications, voicemail applications or banking applications.

17. An automatic interactive natural language system comprising:
means for placing keywords in slots of rule templates in various permutations to create populated templates;
means for scanning production rules to determine which populated template has a production rule match;
means for retaining the populated templates with complete or partial rule matches in an active rule list; and,
means for firing a rule in the active rule list that has highest priority.

18. The system according to claim 17, further comprising:
means for determining, if no rules can be made active, closest probable rules with largest percentage of populated slots over some minimum cut off; and,
means for querying using a natural language dialog a leading question in an attempt to satisfy a rule.

19. The system according to claim 17, further comprising:
means for receiving natural language speech, converting the speech into text; and, parsing the text into the keywords.

20. The method according to claim 17, wherein:
the placing by the placing means is constrained by a slot sizes in the template and the sizes of available keywords;
the placing step is constrained by a number of slots in the template and a number of the available keywords; and,
the slots have weighting factors to determine which of the rules has the highest priority.
